(19) United States
(12) Patent Application Publication
(10) Pub. No.: US 2021/0383314 A1
(43) Pub. Date: Dec. 9, 2021

(54) MANAGEMENT SYSTEM AND METHOD OF USE

(71) Applicant: Robert Cormier, Gibsonia, PA (US)

(72) Inventor: Robert Cormier, Gibsonia, PA (US)

(21) Appl. No.: 17/338,135

(22) Filed: Jun. 3, 2021

Related U.S. Application Data
(60) Provisional application No. 63/034,230, filed on Jun. 3, 2020.

(51) Int. Cl. G06Q 10/08; G06Q 10/06

(52) U.S. Cl. CPC G06Q 10/087; G06Q 10/0631; G06Q 10/083

(57) ABSTRACT

A management system enables control of the process of selling and delivering products by a target completion date. The system tracks leads, orders deliveries, enables vendors to update delivery information, enables clients to view project status through their own devices, provides notifications when a project timeline is at risk of not being met. through a portal. Reports are available based on the data within a portal. Each phase of the project is monitored and the system measures the activity of individuals who are associated with completing the order within project deadlines and also provides success ratios for individual performance.

### BACKGROUND

### 1. Field of the Invention

The present invention relates generally to commerce systems, and more specifically, to a management system that manages data, resources, reporting, documents, and communications to control a process to find and fulfill sales orders. The system includes unique actions that operate alone or in combination in the management of organizations and processes in fulfilling sales orders from a central, unified, integrated computer software platform.

### 2. Description of Related Art

Commerce systems that are known in the art support transactions between parties for goods or services. Prior systems have been applicable to various types of goods and services, but those systems have had various problems and difficulties. For example, some systems have failed to maintain documents in a central location. This often resulted in multiple document searches and correspondence seeking relevant documentation. In other cases, details of a particular project were spread across numerous emails, text messages, paper documents and other information sources. Communication with various reps, employees and agents resulted in a confusion of information that was stored and recorded according to the preferences of the individuals involved making the body of information difficult to manage and share. Such individual practices also resulted in duplication of effort and made transition of responsibilities from one agent to another difficult. Sales opportunities would sometimes be missed, underappreciated, misdirected, or misunderstood due to communication errors.

In addition, information updates and corrections were sometime lost or misdirected due to personnel changes or inconsistent recordkeeping systems and different personnel with different understandings could sometime present fragmented or confusing information to potential clients and customers. In addition, it was sometimes difficult to know the activities of various reps or agents whose reports were poorly organized or delinquent.

Accordingly, a system that could maintain documents and information in a convenient, accessible location and that was stored and expressed in a uniform, comprehensive, consistent manner would afford advantages over such prior art systems.

Also, there was a need for a project management system that fully and accurately describes the sale and delivery of products that form the components of a project, but is generally applicable to many products. The forgoing problems and difficulties, as well as other advantages, are addressed by the presently disclosed invention.

### SUMMARY OF THE PRESENTLY DISCLOSED INVENTION

In accordance with the presently disclosed embodiment, a management system addresses the management of data, documents, resources, and collaborative actions concerning the sale and delivery of products. The disclosed invention may also include billing and payment activities.

In prior art systems, the sale of products such as furniture may be accomplished through a catalog or by selection from a showroom or space. In other cases, product sales are conducted through processes that include identifying a sales lead, qualifying that lead, establishing budgetary quotes, developing a contract (that sometimes is a written document), receiving a deposit payment, managing customer relations through a product selection process, creating a quote that encompasses the client's actual choices, creating purchase orders, communicating with vendors to manage those purchase orders through shipment, notifying the purchaser of product shipments, and collecting payments for the products. In the case of purchasers who are franchisee customers, their product selection is guided by standard requirements for their franchise brand.

As one example of a sales project, individuals may select new products that are manufactured at one location and then delivered to another location such as a business, hotel, or office. The product selections made by the individual are specific and the units that are delivered must match the product specimen that the individual has viewed in the form of a full size specimen, a photograph, a specification, or other representation of the product.

As one specific example, when supplying furniture to furnish larger spaces such as offices or hotels, the furniture is ordered by room, room type, designated area, or space defined according to use such as a lobby or office. The exact content of the pieces may vary provided the general content is maintained.

One of the problems commonly associated with purchases of common products such as furniture, purchasing systems may have limited efficiency and, frequently, need to maintain multiple systems to fulfill the order.

For example, control of the process for delivering or shipping/receiving many rooms of furniture at the same or nearly the same time is difficult and requires communication between many parties such as designers, purchasers and transporters.

Accordingly, although improvements have been made in product purchasing and delivery, many difficulties and shortcomings have remained.

In accordance with the presently disclosed invention, a system is disclosed for managing sales and delivery of components of a project. In the project, at least one vendor supplies at least one component to a client. The system is responsive to inputs from the vendor and from the client. The system includes a digital network that defines a template that determines the scope and timing of the project. The template also monitors the progress of said project while amending the scope and timing of the project and confirming the completion of the project. The system also includes a first digital portal that is in communication with the digital network. The first digital portal includes at least one graphical user interface that is responsive to data that is received from the digital network. The graphical user interface also receives commands from a vendor and is responsive to data and information entered by the vendor. The first digital portal enables the vendor to respond to information requests from the digital network and enables the vendor to provide data and information to the digital network at the initiative of the vendor. In addition, the system includes a second digital portal that is in communication with said digital network and in communication with said first portal through said digital network. The second digital portal includes at least one graphical user interface that is responsive to data from said digital network, commands from a client, and data and information that are entered by the client. The second digital portal enables the client to respond to information requests from the digital network and also enables the client to provide data and information to the digital network at the initiative of the client.

Preferably, inputs to the digital network include leads for new projects wherein the leads may be assigned to individuals on the basis of geographical territory. The digital system monitors communications between the individual and the client and/or between the individual and the vendor as the client and vendor define the scope of the project.

The digital system may monitor the progress of the project toward completion. The digital system may open an order that defines the initial scope of an order, populate the order by identifying products and services that satisfy the order and subsequent modifications of the order, and fill the order by monitoring shipment and delivery of products and services that satisfy the order and any modifications of the order. The system may also determine that an order is complete and then verifying that the order is complete.

Also preferably, digital rules may be applied to the digital network to alter the template that is defined by the digital network.

In cases in which there is more than one vendor, a respective first portal may be associated with each of the vendors and each of the first portals is electronically isolated from all other first portals. Similarly, where there is more than one client, a respective second portal may be associated with each client and each second portal is electronically isolated from all other second portals.

It also may be preferable that the template that is defined by the digital system stores inputs to the digital network made by each of the individuals such that the activity of each individuals may be compared and evaluated.

The presently disclose invention also may also have a digital network that includes a set of modules that define the template of said digital network. The modules may be subject to electronic rules that can be added by said vendor or by said client, the electronic rules creating connectivity between or among the modules to integrate the respective functions of the modules.

Other advantages, features and improvements will become apparent to those skilled in the art as the presently preferred embodiment of the disclosed invention proceeds.

### BRIEF DESCRIPTION OF THE DRAWINGS

A presently preferred embodiment of the disclosed inventive system, as well as a preferred mode of use, and further objectives and advantages thereof, may be understood by reference to the following detailed description of a presently preferred embodiment when read in conjunction with the accompanying drawings, wherein:

FIG. 1 is a diagram of a management system in accordance with a preferred embodiment of the present application;

FIG. 2 is a diagram of a digital system that enables the system of FIG. 1;

FIG. 3 is a simplified schematic of the portal of FIG. 1;

FIG. 4 is a process chart of the portal of FIG. 1;

FIG. 5 is a diagram of the data flow within the portal of FIG. 1;

FIG. 6 is a front view of the portal of FIG. 1 in use;

FIG. 7 is a simplified schematic of the room configuration data of the portal of FIG.

FIG. 8 is a simplified schematic of the report module of the portal of FIG. 1;

FIG. 9 is a simplified schematic of the shipping module of the portal of FIG. 1; and

FIG. 10 is a flowchart of a method of managing the purchase and delivery of furniture.

While the system and method of use of the present application is susceptible to various modifications and alternative forms, specific embodiments thereof have been shown by way of example in the drawings and are herein described in detail. However, the description of specific embodiments herein is not intended to limit the disclosed invention to the particular embodiment. On the contrary, the presently disclosed invention includes all modifications, equivalents, and alternatives falling within the scope of the present application, including the claims included.

### DETAILED DESCRIPTION OF A PRESENTLY PREFERRED EMBODIMENT

Illustrative embodiments of the system and method of use of the presently disclosed invention are provided below. In the development of any actual embodiment of the disclosed management system, the client's or user's specific goals will involve numerous implementation-specific decisions. Examples include compliance with system-related and business-related constraints that vary from one implementation to another.

The system and method of the presently disclosed invention overcome one or more of the above-mentioned problems and difficulties that are commonly associated with conventional purchasing, management, and delivery systems.

In contrast to the prior art, the presently disclosed invention provides tools to efficiently initiate, import, assign, track, request resources or support, and manage documentation pertaining to leads and marketing campaigns that are associated with the sale and delivery of products such as, for example, furniture. The presently disclosed invention supports series of routines and requirements that are performed by reps, employees and agents and enables managers to measure the activity level and competency of each rep, employee or agent through each stage of the sales and delivery process. In addition, the presently disclosed invention includes selecting products for purchase, quoting those products, and assigning individuals respective roles to be performed with respect to those products. The disclosed invention also supports the identification of all tasks needed to achieve project completion, assigning those tasks to appropriate roles, estimating the time required for completing each task (where such estimates may be made manually or through artificial intelligence or machine learning), and identifying a due date for each task.

In addition, the disclosed invention may include identifying prerequisite conditions that must be satisfied before beginning a designated task, automatically notifying persons assigned to the designated task that execution is to begin, triggering warnings when tasks become past due, automated creation of purchase orders, and direct placement of orders that are accessed and received through an individual's own login credentials.

Further, the presently disclosed invention may also include: receiving documents that vendors have uploaded directly to a dedicated portal; creating and managing multiple shipments on a single purchase order; messaging directly to purchasers and vendors through item specific triggers, recipient specific triggers, and lined purchase order triggers that indicate when purchase orders require an update from vendors; and correspondence concerning project performance to clients and customers together with visibility of accounting and payment functions throughout the term of the project.

Preferably, the presently disclosed invention, provides process management for delivery and acceptance including the sequence in which the goods are delivered, the quantities for each delivery, vendor updates for estimated shipping dates, vendor uploading of tracking information when products are shipped, capability for purchasers to select shipping freight options and applying selected options to specific orders, automated alerts that indicate when there is a high risk of out-of-sequence deliveries (though artificial intelligence and/or machine learning), shipping different quantities of products to multiple delivery locations on a single purchase order, enabling the recipient of the products to download resources such as installation instructions and delivery schedules, and enabling recipients of goods to use their portal to upload photographs and documents from their location, to transmit requests, and to report claims with critical resolution deadlines, and to review invoices and payment activity. These and other unique features of the disclosed system and method are described herein and illustrated in the accompanying drawings.

The system and method of use are described, both as to their structure and operation, from the accompanying drawings taken in conjunction with the accompanying description. While various embodiments of the disclosed system are described herein, various components, parts, and features of different embodiments may be combined and/or interchanged within the scope of the presently disclosed invention.

The preferred embodiment herein described is not exhaustive and does not necessarily limit the subject invention

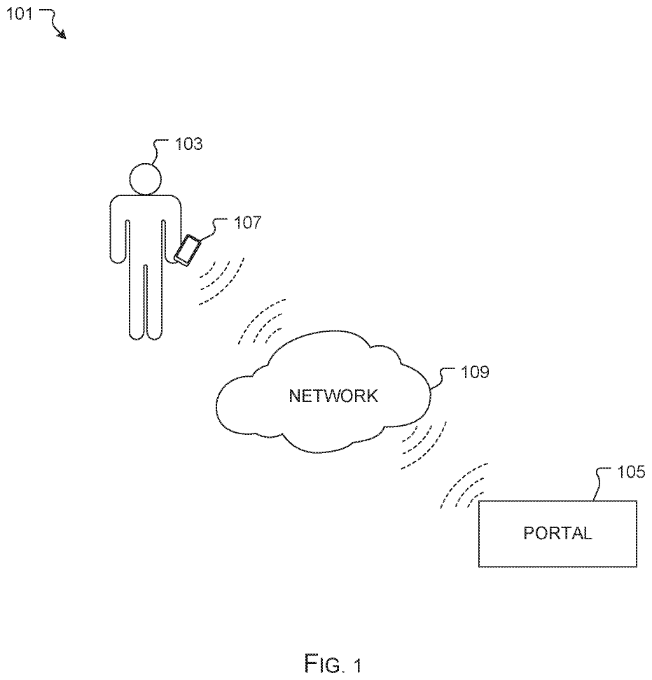

Referring now to the drawings wherein like reference characters identify corresponding or similar elements throughout the several views, FIG. 1 depicts a diagram of a management system in accordance with a preferred embodiment of the presently disclosed invention.

As illustrated in FIG. 1, the management system 101 overcomes one or more of the above-listed problems commonly associated with conventional product purchase and delivery systems. System 101 includes a user 103 who is in digital or electronic communication with a portal 105 (that may be in the cloud). Communication with portal 105 is established via a computing device 107 over an electronic or electrical network 109.

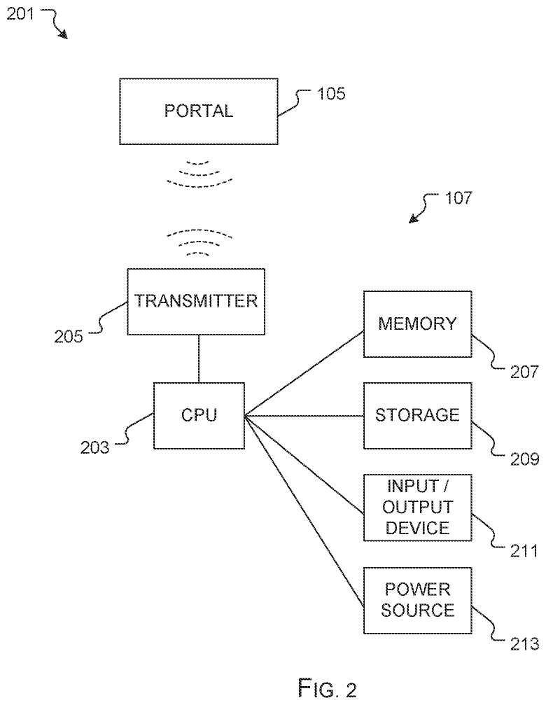

FIG. 2 illustrates a digital electronic environment 201 that includes computing device 107, network 109 and portal 105 as shown in FIG. 1. Digital environment 201 includes a CPU 203 that controls the components of the computing device 107. As shown in FIG. 2, computing device 107 includes components such as a memory 207, a storage device 209, input/output devices 211, a power source 213 and a transmitter 205.

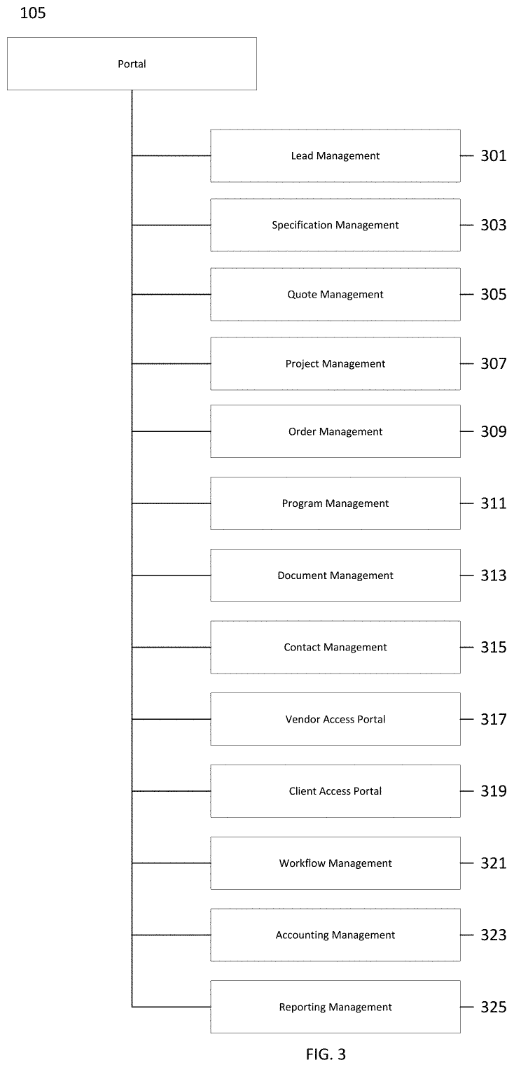

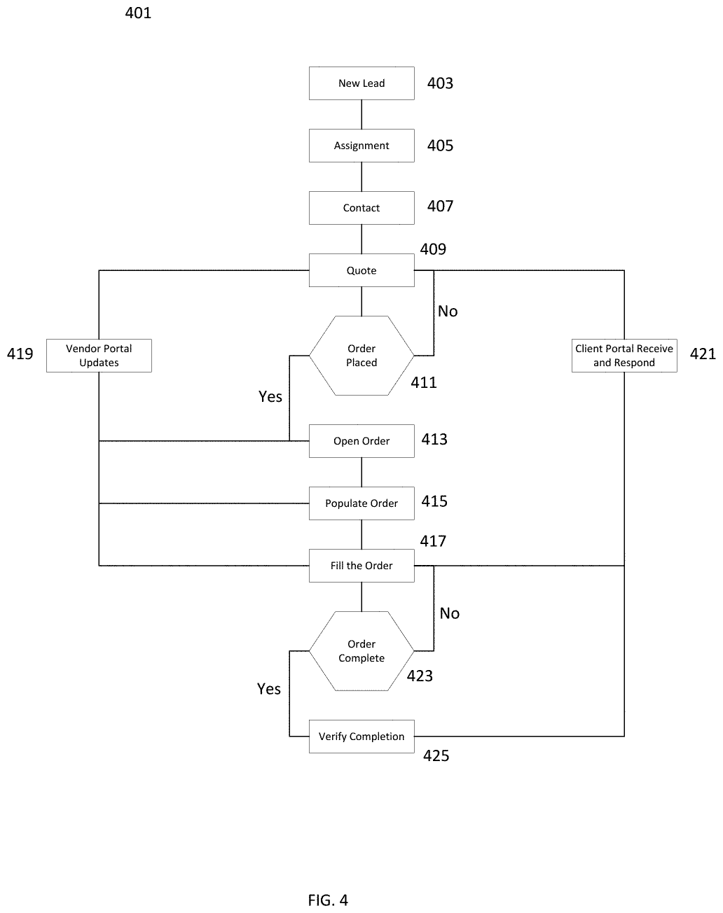

FIGS. 3 and 4 illustrates further details of the presently disclosed invention. FIG. 4 includes a client portal 421 that is in communication with other portions of the disclosed system that are shown in FIG. 4. Client portal 421 may communicate with the other elements of the system through microwave, or rf connection or by other convenient manner.

FIGS. 1-4 illustrate an embodiment of the disclosed system for managing sales and delivery of components of a project. The components of the project are supplied by at least one vendor. There may be multiple vendors and each vendor supplies at least one component to a client who is the purchaser of the project. FIG. 1-4 illustrate that the disclosed system is responsive to inputs from at least one vendor and from at least one client in the following manner.

The digital network 109 is further detailed as various modules 301-325 in FIG. 3 and as system components 403-417 and 423-425 in FIG. 4 as hereinafter discussed. Digital network 109 defines a template that supports management over the scope and timing of the project, monitoring the progress of said project, amending the scope and timing of said project, and confirming the completion of said project. Digital portal 105 (also shown as “vendor portal updates” 419 in FIG. 4) is in communication with digital network 109. Digital portal 419 includes at least one graphical user interface that is responsive to data from digital network 109, commands from a vendor, and data and information that is entered by the vendor. Digital portal 419 enables the vendor to respond to information requests from digital network 109 and also enables the vendor to provide data and information to digital network 109 at the initiative of the vendor. FIG. 4 also illustrates a second digital portal 421 (shown as “Client Portal Receive and Respond” 421 in FIG. 4). Digital portal 421 is in communication with digital network 109 and is also in communication with digital portal 419 through digital network 109. Digital portal 419 includes at least one graphical user interface that is responsive to data from digital network 109, commands from a client that is operating the graphical user interface, and data and information that is entered by the client. Digital portal 419 enables the client to respond to information requests from digital network 109 and also enables the client to provide data and information to digital network 109 at the initiative of the client.

Referring specifically to FIG. 3, the digital network includes a plurality of template modules that, collectively, define functions of the digital network and the disclosed management system. FIG. 3 illustrates modules for lead management 301, specification management 303, quote management 305, project management 307, order management 309, program management 311, document management 313, contract management 315, vendor access portal communications 317, client access portal communications 319, workflow management 321, accounting management 323, and reporting management 325 although other modules pertaining to other functionalities could also be included as part of the modular array. Portal 105 enables the vendor to access and manipulate information, data, files, and documents that are maintained in digital network 109. Vendor portal 105 includes tools for working with the modules for lead management 301, specification management 303, quote management 305, project management 307, order management 309, program management 311, document management 313, contract management 315, vendor access portal communications 317, client access portal communications 319, workflow management 321, accounting management 323, and reporting management 325 Each of these tools in combination with the respective module facilitates part of the process of offering, selling, delivering, project management of, and procurement of furniture or other products in accordance with the disclosed system. Additionally, portal 105 may include bi-directional synchronization with third-party data sources to that provide data to portal 105 that may also be updated and/or used at portal 105. In the presently disclosed invention, portal 105 enables control over the process of sales, delivery, client management, project management, procurement, and design specification of the subject product such as furniture. The disclosed system results in a more efficient process and a more effective process in comparison to prior art methods. As a result, service to clients and customers is improved. Referring again to FIG. 4, the management system 401 is depicted. FIG. 4 illustrates that information for a new project lead 403 is obtained and entered in lead management tool 301 via portal 105. Responsibility for the lead is then assigned 405 or otherwise processed in preparation for contact 407 with the potential client or purchaser. The lead may be assigned automatically as, for example, according to sales territories that may be created and stored according to state, county, zip code, or other geographical metric. Based on the result of contact 407, the lead is further processed, re-contacted, quoted at 409. When there is agreement between the vendor and the client, an order is placed at 411 for the client. An order is then opened at 413 and data that is related to the product purchased is populated in the order at 415. Order fulfillment is then practiced until the order is filled at 417.

Vendor updates may be provided directly to the vendor access portal 419. Also, updates may also be provided directly to the client portal 421. Updates, corrections, and modifications may by directly exchanged between the vendor portal 419 and the client portal 421 across the electronic network 109. Both vendors and clients are provided with their own respective user login credentials to maintain confidentiality of protected information in the system.

When the order is complete at 423 it is verified by a person on-site as complete 425, via the Client Portal 421.

The system shown in FIGS. 1-4 may be especially useful to an individual who is facilitating the execution of a sale of products between one or more vendors and one or more clients or customers. For example, the disclosed system monitors contacts between the individual who is facilitating the sale and the client and/or between the individual who is facilitating the sale and the one or more vendors. Such monitoring may occur while the vendor and the client communicate between vendor portal 419 and client portal 421 through network 109 to define the scope of the quote for a project. Such monitoring may also occur at any time throughout the sale process such as after an order is placed to monitor delivery dates and times or at times when there is a product change in the order or any other modification or change to the order. Such monitoring capability is an important advantage over the prior art systems because the vendor, the client, and the facilitating individual all have current, accurate information concerning the status of the project and any problems or risks that threaten timely completion of the project. For example, the disclosed system will notify each of the vendor, the facilitating individual, and the client if a delay in the delivery of a product affects the timely delivery of other products that are included in the project.

As an example of such monitoring by the disclosed system, the disclosed digital system may monitor the progress of said project toward completion by opening an order that defines the initial scope of an order at 413, populating the order by identifying the products and services that will satisfy the order as well as any modifications of the order at 415, and filling the order by monitoring shipment and delivery of products and services that satisfy the order and any modifications of the order at 417.

The communications of the vendor with the network 109 may be through the vendor portal 419 and communications of the client with network 109 may be through the client portal 421. The vendor/client communications may be facilitated by another individual who is monitoring the system and who may take appropriate action to aid at least one vendor to submit appropriate products and an appropriate delivery schedule to provide a quote that the client finds acceptable. The facilitating individual may also aid the vendor and the client to determine when the vendor and client have placed an order and to complete any necessary actions to memorialize that order such as, for example, developing and completing a purchase order that meets internal requirements of the client and is acceptable to the vendor or to multiple vendors.

In one embodiment of the presently disclosed management system of FIGS. 1-4, the vendor and/or the client and/or a facilitating individual may apply digital rules to the vendor portal or to the client portal or to the network 109 to vary the template that is defined by the digital network 109 or the vendor portal 419 or the client portal 421. Such digital rules enable the modification or amendment of the management system to more specifically satisfy desires of the vendor and/or the client and/or the individual facilitator for effective operation of the system. For example, the facilitator may apply digital rules to expand, contract or vary contact information as to vendor, the client, and/or the facilitator himself. In this way, each of the parties will have current, consistent contact information and such information will not be lost, misdirected or misinterpreted over time due to changes in personnel or structural or procedural changes in the enterprise of the vendor or the client.

As another example of the use of electronic or digital rules, the rules may be used to define new terms or to redefine existing terms to reconcile any differences in understanding or intention by the vendor or the client. Such rule changes may make the quote and/or the order and/or fulfillment of the order more certain than prior art systems. Also, such rules may make increase efficiencies of the disclosed management system. For example, a definition may be broadened to support more simplified accounting of various products that are delivered in satisfaction of an order or, alternatively, a definition may be narrowed to enable more precise accounting of products that are delivered in satisfaction of an order.

The management system of FIGS. 1-4 also enables improved security for providing a quote and throughout the order fulfillment process. For example, in cases where there are more than one vendor, a respective portal is associated with each of the vendors and each of the vendor portals is electronically isolated from all other vendor portals. Each vendor has a respective passcode and username so that multiple vendors do not have access to the confidential information of other vendors—especially with regard to vendor quotes and client orders.

Similarly, in circumstances where there is more than one client, a respective client portal is associated with each client and each client portal is electronically isolated for all other client portals. Each client has a respective passcode and username.

The disclosed management system may support enhance capability to evaluate the performance of persons such as individual facilitators as well as vendors and clients. For example, the disclosed system monitors and stores information pertaining to each lead, each quote, and each order over multiple leads, quotes and orders. In this way, network 109, vendor portal 419 and client portal 421 define a template that stores inputs to the digital network and outputs from the digital network. This digital information may then be applied for comparison and evaluation of the vendors, clients, and/or individuals involved. For example, such information may be used to evaluate whether an individual facilitator consistently and timely follows up with on leads that have been assigned to them. In this way, the disclosed system may provide metrics that are useful for predicting future performance of an individual or for providing appropriate training experiences for said individual or for giving appropriate work assignments to such individual.

As another example, such information may be useful to evaluate the percentage of times that a vendor has timely and accurately responded to a request for quotations or the percentage of times that a client who has requested a quote has followed though to place an order. Such information may be strategically useful for vendors, facilitators, and clients. For example, it may be helpful in managing and training facilitators as to those areas where their performance could be strengthened. As another example, such information may be useful to vendors in committing to a given level of effort for quotes to a particular client or, conversely, to clients in electing to work with certain vendors toward an order.

As previously explained, the system of FIG. 1-4 may define a template that tracks completion dates for the project and completion dates for portions of the project within the overall project. In some cases. completion dates for one portion of the project are interrelated with one or more completion dates of another portion of said project. In those instances, the template defined by the digital system may communicate with said vendor or with said client to advise said vendor or said client when a failure to meet the completion date of one portion of the project will also cause a failure to meet the completion date of another portion of the project.

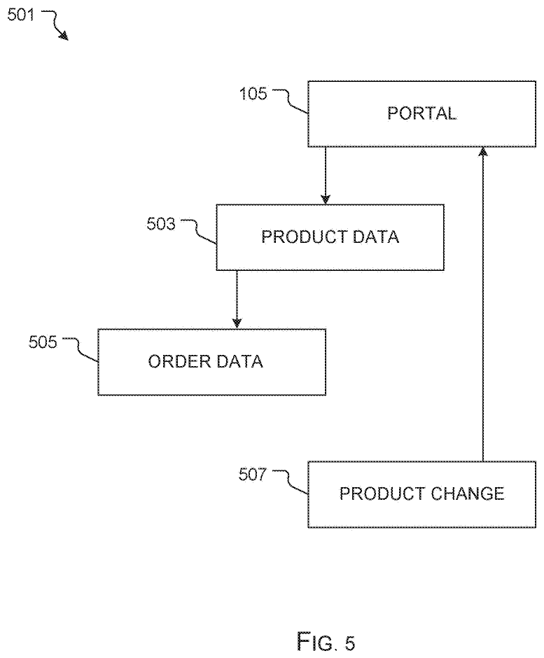

Connectivity between one completion date and other completion dates, describes an example of how vendors, facilitators and/or clients may apply electronic rules to the system modules to define or redefine the template of said digital network. By applying electronic rules to the system modules, the electronic rules may create connectivity between or among the modules to integrate respective functions of the modules. FIG. 5 illustrates that portal 105 facilitates the control of product definitions 501 for products that are offered to the client. A set of product data 503 is offered to clients. When a client orders a product, the product data is delivered to order data 505. If a product is changed as at 507, the product change is communicated to the vendor portal 105 and the product data selection 503 according to the new product data. The system maintains a record of date, time, and name of the individual making the product change.

The system may also recognize those circumstances where a product change may affect other parts of the overall order. In those circumstances, the system will alert the responsible parties that they should review their respective areas of responsibility and take any appropriate action.

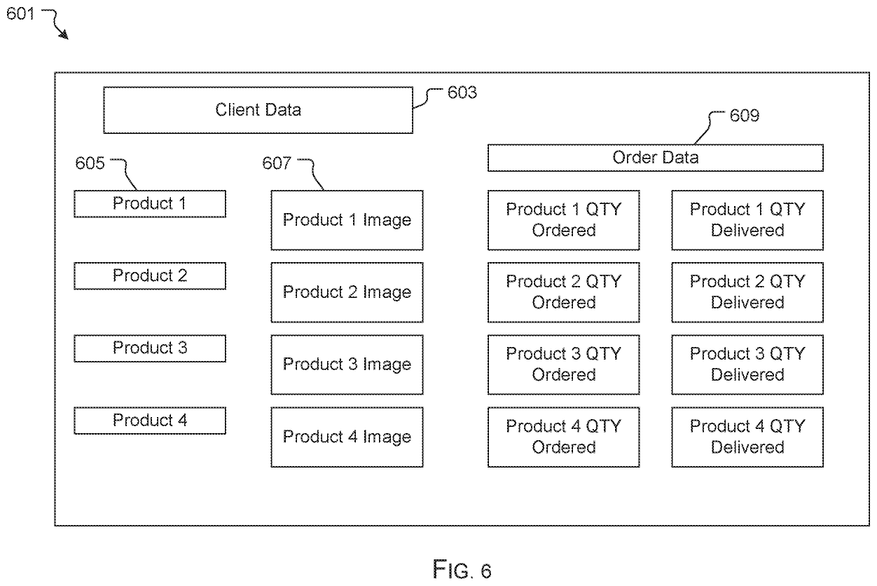

FIG. 6 illustrates and example of the management system in use. View 601 includes client data 603 such as name, address, phone number or email address. A set of products 605 is listed and a respective product image 607 is shown to facilitate the identification of the product. Order data 609 such as the quantity ordered and quantity delivered is also available.

FIG. 6 also shows that the disclosed system provides alerts for delayed orders or orders that will not be delivered within the scheduled time. FIG. 6 also shows the disclosed system alerts users of additional actions that are required by the user.

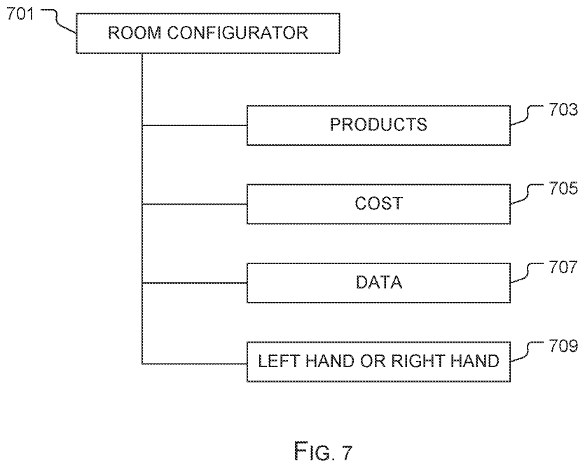

FIG. 7 illustrates an example wherein product data includes a set of furniture that is aggregated into a room configuration 701 to efficiently arrange furniture for a room in a manner that is functional and aesthetically pleasing. The room configuration 701 includes products 703 to be grouped, the cost 705, the features 707 or other data relative to the products and an identifier of left-hand or right-hand 709. The identifier such as left-hand or right-hand 709 would alter the products 703 to conform with an aspect of the room for which the furniture is ordered such as the location of the door with respect to the rest of the room.

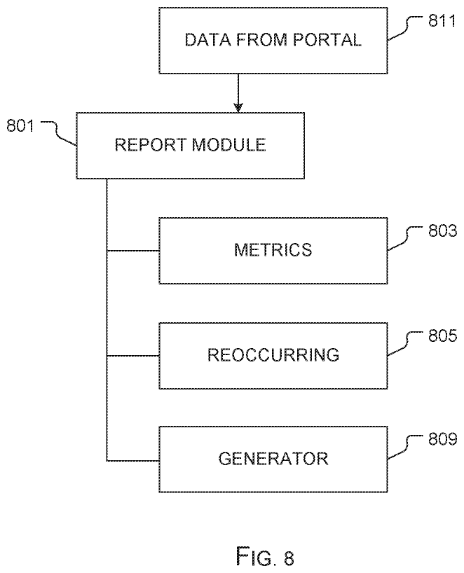

FIG. 8 depicts an embodiment of Reporting Management 325. Report module 801 includes metrics 803 such as product ordered, potential leads and the like that are quickly displayed and generally useful. Reports could be reoccurring 805 and contain information that is consumed by a single group or by many. A report generator 809 allows for custom filters or algorithms to provide insight into any portion of portal 105. The output of report module 801 may be graphs, charts, lists, or the like and the colors or other indicators could be used to facilitate observation of the process or system. Also, this information may be exported to external files where it may be printed or saved.

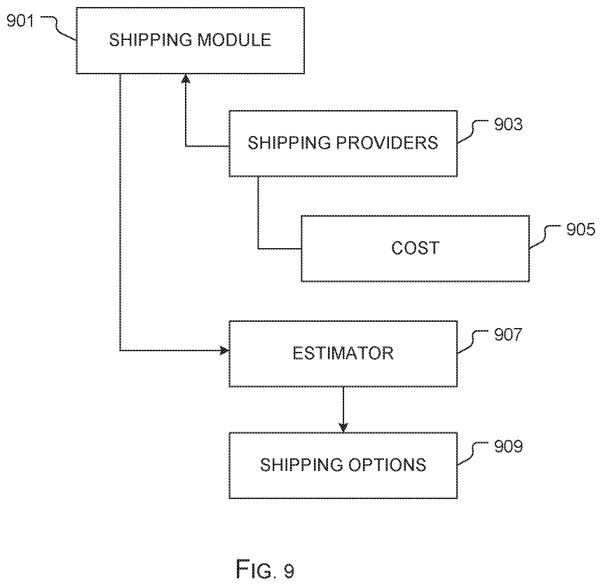

FIG. 9 depicts an embodiment of the program management 311 tool. Shipping module 901 allows for shipping providers 903 to provide their cost 905 or other information about their services. Such information may apply to an entire purchase order or one or more selected shipments of products as specified by the purchase order. Venders may provide a list of criteria that are required to enable freight companies to provide quotes. Information that is uploaded by vendors is automatically applied to any request for freight quotes that are sent to transportation providers. This information from the shipping providers 903 is transferred to an estimator 907 that combines data from portal 105 to give projected options 909 for an order to be shipped. Shipping providers 903 could be internal or external to the system or organization.

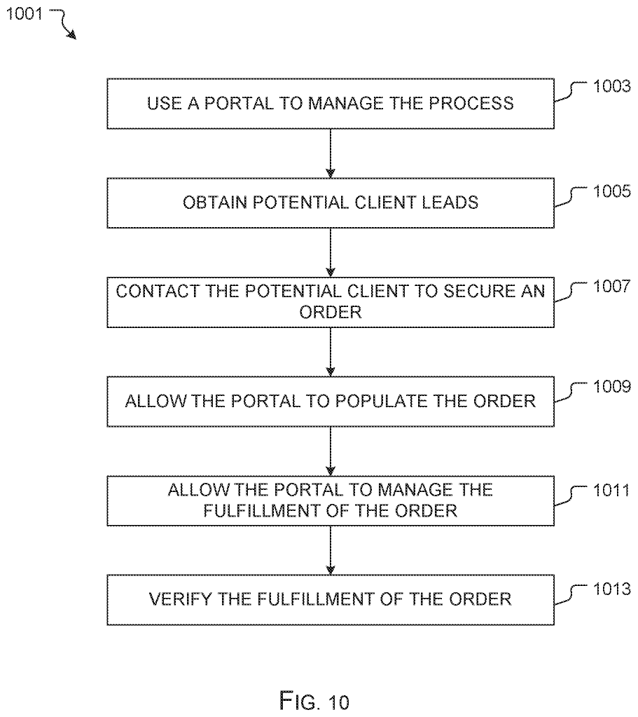

FIG. 10 illustrates the application of the disclosed management system to the sale of furniture. Method 1001 includes using a portal to manage the process (such as by sales, quoting, project management, product library, order management, and client/vendor portals) 1003, obtaining potential client leads 1005, communicating between the user and the potential client through the call, video call, and email functions of the system 1007, allow the portal to populate the order 1009, allowing the portal to manage the fulfillment of the order and enabling clients to monitor the activity and status of orders throughout the project 1011 and verifying the fulfillment of the order 1013.

The particular embodiments disclosed herein may be altered or modified in variations that are within the scope of the disclosed invention. Although presently preferred embodiments are shown and described herein, the presently disclosed invention is not limited to those embodiments, but includes changes and modifications that do not depart from the scope of the disclosed invention.

What is claimed;

1. A management system comprising:
a portal operating within a digital environment including;
at least one computing device; and
a network;
wherein the portal controls the flow of data, documents, files and supporting resources related to obtaining leads, contacting leads, accepting orders, managing specifications, managing projects, filling orders and shipping orders for products; and
wherein the portal communicates and measures user performance at each phase.

2. The system of claim 1 wherein the system supports project and resource management services.

3. A management system comprising:
a portal operating within a digital environment including;
at least one computing device; and
a network;
wherein the portal includes a room configurator that tracks data related to at least one product to be delivered to a single space; and
wherein the room configurator tracks the left-hand or right-hand orientation of the space.

4. The management system of claim 3 wherein said management system quantifies available labor resources.

5. The management system of claim 3 wherein said management system assigns roles to tasks and project templates that are created by a user.

6. The management system of claim 3 wherein said management system establishes a central location for storage of project specific documents and files.

7. The management system of claim 3 wherein said management system sets critical due dates for timeline altering tasks, where such timeline altering tasks effect the target completion date of a project.

8. The management system of claim 7 wherein said management system established automated alerts and warning when completion of a project within the allotted time is at risk.

9. A method of managing the sale and distribution of products, said method comprising the steps of:
using a portal to achieve a target completion date for an order wherein damages or increased costs are potential consequences of non-completion of the order by the target completion date;
automatically assigning potential client leads to individuals who are responsible for serving a selected geographic region;
contacting the potential client with respect to an order to manage specifications of the order and to establish a record to all communications according to date, time, and identity of the correspondents;
populating the portal with selective information;
allowing the portal to manage the fulfillment of the order based on the target completion date for the project; and
verifying the fulfillment of the order.

10. A system for managing sales and delivery of components of a project wherein at least one vendor supplies at least one component to a client, said system being responsive to inputs from said vendor and from said client, said system comprising:
a digital network that defines a template for the scope and timing of said project, monitoring the progress of said project, amending the scope and timing of said project, and confirming the completion of said project;
a first digital portal that is in communication with said digital network, said first digital portal including at least one graphical user interface that is responsive to data from said digital network, commands from a vendor, and data and information entered by said vendor, said first digital portal enabling said vendor to respond to information requests from said digital network and also enabling said vendor to provide data and information to said digital network at the initiative of said vendor; and
a second digital portal that is in communication with said digital network and in communication with said first portal through said digital network, said second digital network including at least one graphical user interface that is responsive to data from said digital network, commands from a client, and data and information entered by said client, said second digital portal enabling said client to respond to information request from said digital network and also said client to provide data and information to said digital network at the initiative of said client.

11. The system of claim 10 wherein inputs to said digital network include leads for new projects and wherein said leads are assigned to individuals on the basis of geographical territory.

12. The system of claim 11 wherein said digital system monitors contacts between said individual and said client and/or between said individual and said vendor as said client and said vendor define the scope of said project.

13. The system of claim 11 wherein said digital system monitors the progress of said project toward completion.

14. The system of claim 13 wherein said digital system monitors the progress of said project toward completion by opening an order that defines the initial scope of an order, populating the order by identifying the products and services that will satisfy the order and any modifications of the order, and filling the order by monitoring shipment and delivery of said products and services that will satisfy the order and any modifications of the order.

15. The system of claim 14 wherein said digital system determines that an order is complete and then verifying that the order is complete.

16. The system of claim 10 wherein said vendor communicates with said digital system through said vendor portal and wherein said client communicates with said digital system to determine define a quote for said project and to determine when an order is placed.

17. The system of claim 14 wherein said vendor communicates with said digital system through said portal to define said quote and to determine that an order has been placed, opened, populated, and filled.

18. The system of claim 14 wherein said client communicates with said digital system through said second portal to define the terms of said quote, and to determine when an order is placed, filled, and completed and to verify completion of the order.

19. The system of claim 10 wherein digital rules are applied to said digital network to vary the template that said digital network defines.

20. The system of claim 19 wherein said digital rules define terms that are used to define said quote.

21. The system of claim 19 wherein said digital rules identify the vendor and the client.

22. The system of claim 10 wherein there are more than one vendor and wherein a respective first portal is associated with each of said vendors and wherein each of said first portals is electronically isolated from all other of said first portals.

23. The system of claim 10 wherein there are more than one client and wherein a respective second portal is associated with each of said clients and wherein each of said second portals is electronically isolated for all other of said second portals.

24. The system of claim 10 wherein the template that is defined by said digital system stores inputs to said digital network made by each of said individuals such that the activity of each of said individuals may be compared and evaluated.

25. The system of claim 10 wherein the template that is defined by said digital system tracks completion dates for the project and for completion dates for portions of the project.

26. The system of claim 25 wherein completion dates for a portion of the project is interrelated with the completion date of another portion of said project, the template that is defined by said digital system communicating with said vendor or with said client to advise said vendor or said client when a failure to meet the completion date of one portion of said project will also cause a failure to meet the completion date of another portion of said project.

27. The system of claim 19 wherein said digital rules can be applied to said digital network by said vendor or by said client.

28. The system of claim 10 wherein said system stores inputs from said one or more vendors to support an evaluation of the vendors.

29. The system of claim 10 wherein said system stores inputs from said one or more clients to support an evaluation of said clients.

30. The system of claim 10 wherein said digital network includes a set of modules that define the template of said digital network, said modules being subject to electronic rules that can be added by said vendor or said client, said electronic rules creating connectivity between or among said modules to integrate the respective functions of said modules.

31. The system of claim 24 wherein the evaluation of said individuals provides metrics for predicting future performance of said individual or for providing appropriate training experiences for said individual or for giving appropriate work assignments to such individual.
